(19) United States
(12) Patent Application Publication
(10) Pub. No.: US 2008/0158767 A1
(43) Pub. Date: Jul. 3, 2008

(54) CONNECTING STRUCTURE AND METHODS FOR ELECTRICALLY CONNECTING CONDUCTIVE MEMBERS

(75) Inventors: GANG ZHONG, Shenzhen (CN); QI LIU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/942,722

(22) Filed: Nov. 20, 2007

(30) Foreign Application Priority Data
Dec. 29, 2006 (CN) 200610201471.4

(51) Int. Cl. H05F 3/00

(52) U.S. Cl. 361/220

(57) ABSTRACT

An exemplary connecting structure (30, 50) is used to electrically connect two conductive members (32, 34, 52, 54). The connecting structure includes an adhesive layer (36, 56) and a conductive element (40, 60). The adhesive layer is used to connect the conductive members and defines a through hole (38, 58). The at least one conductive element is received in the through hole. The at least one conductive element is electrically connected to the conductive members respectively. The present invention also provides a connecting method to make the connecting structure.

### BACKGROUND OF THE INVENTION

1. Field of the Invention

The present invention relates to connecting structures and methods for electrically connecting conductive members.

2. Discussion of the Related Art

Electronic devices with metallic housings made of metal such as magnesium alloy or aluminium alloy are more appealing and preferable to users. In order to make the housings attractive, an anodic treatment is generally performed on the housings. However, the electronic components inside the housing generate static electricity. Usually the static electricity cannot be transferred out of the housing because the housing is performed by anodic treatment and a surface of the housing is insulating. Thus, the electronic components are likely to be damaged and interfered by the static electricity.

Some electronic devices includes a conductive member to minimize static electricity. The housing of the electronic device may include a hole to receive the conductive member. The conductive member is connected to the housing by an adhesive tape with insulating properties. The conductive member can transmit some static electricity out of the housing. However, most static electricity cannot be transmitted out of the housing because the surface of the housing is insulative, due to the anodic treatment, and the connection point of the housing and the conductive member may not conduct properly.

Therefore, a connecting structure and a method for conductive members which can conductively connect conductive members are desired.

### SUMMARY

An exemplary connecting structure is used to electrically connect two conductive members. The connecting structure includes an adhesive layer and a conductive element. The adhesive layer is used to connect the conductive members and defines a through hole. The conductive element is received in the through hole. The conductive element is electrically connected to the conductive members respectively.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present connecting structure and a method for electrically connecting conductive members. Moreover, in the drawings, like reference numerals designate corresponding parts throughout the several views, and all the views are schematic.

FIG. 1 is an isometric view of a connecting structure in accordance with a first embodiment of the present invention.

FIG. 2 is an exploded, isometric view of the connecting structure of FIG. 1.

FIG. 3 is a side, cross-sectional view of the connecting structure of FIG. 1 taken along line III-III.

FIG. 4 is an enlarged view of a circle position IV of FIG. 3.

FIG. 5 is a side, cross-sectional view of a connecting structure in accordance with a second embodiment of the present invention.

FIG. 6 is an enlarged view of a circle position VI of FIG. 5.

### DETAILED DESCRIPTION OF THE EMBODIMENTS

The present invention provides a connecting structure and method for conductive members used in electronic devices. Exemplary connecting structures and methods for conductive members are described in detail as follows.

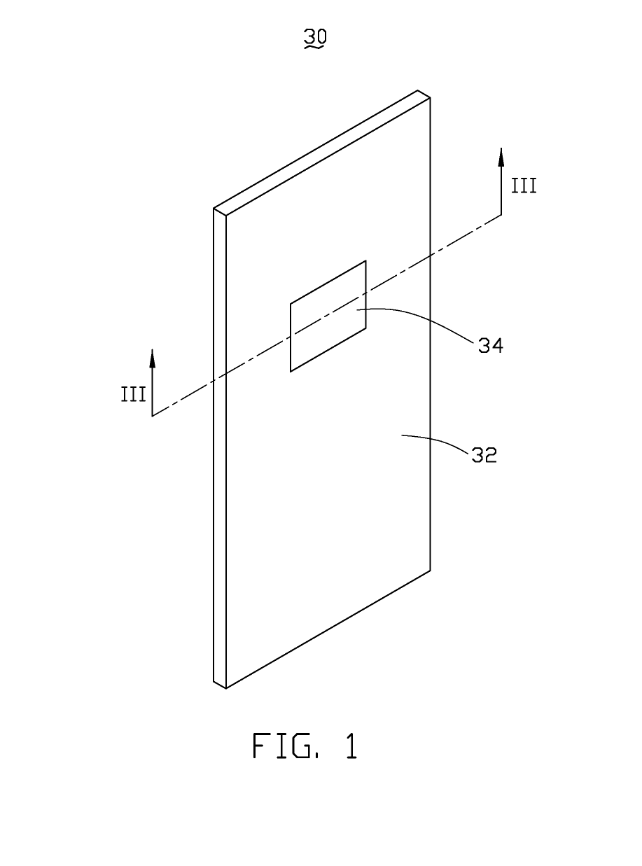

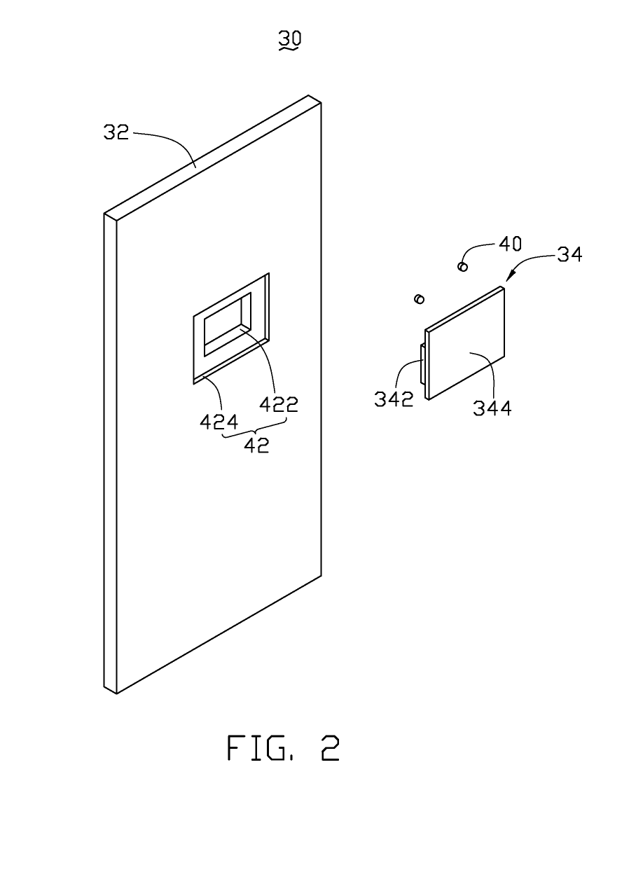

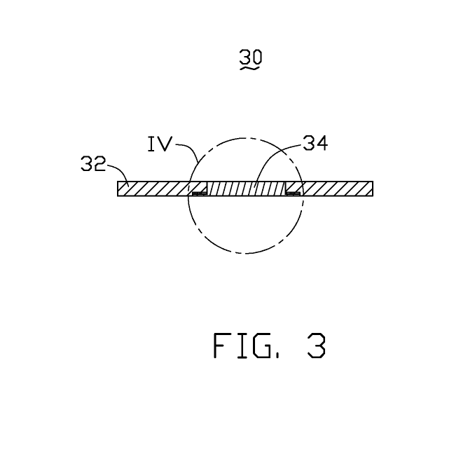

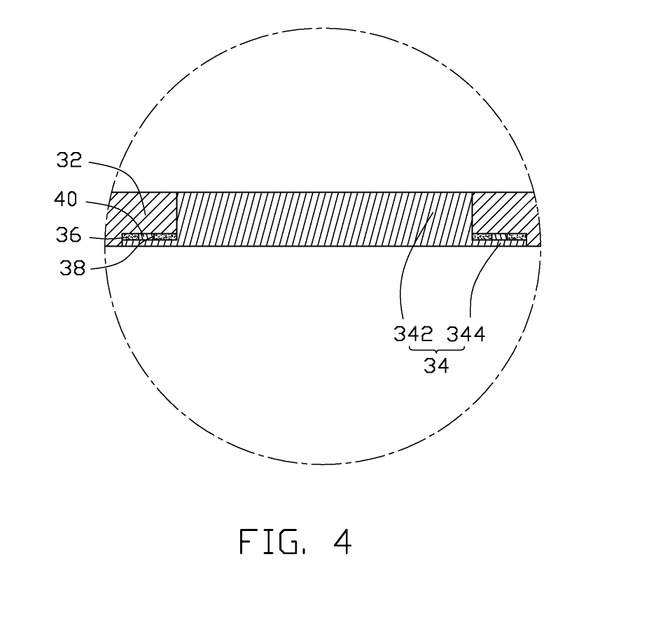

Referring to FIGS. 1-4, a connecting structure 30 in accordance with a first embodiment includes an adhesive layer 36 and two conductive elements 40. The connecting structure 30 is used to connect a first conductive member 32 to a second conductive member 34.

The first conductive member 32 is a housing of an electronic device. The first conductive member 32 defines a receptacle hole 42. The receptacle hole 42 includes a through hole 422 from a first surface (not labeled) to a second surface (not labeled) of the first conductive member 32, and a depression 424 formed in the first or second surface at a periphery of the through hole 422. The depression 424 communicates with the through hole 422 forming a ledge at a bottom of the depression 424 connecting to a surrounding sidewall of the through hole 422.

The second conductive member 34 includes a base portion 342 and a flange portion 344 extending around a bottom edge of the base portion 342. A shape and a size of the base portion 342 correspond to the through hole 422 of the first conductive member 32. A shape and a size of the flange portion 344 correspond to that of the depression 424 of the first conductive member 32. The adhesive layer 36 is deposited on a top surface of the flange portion 344. The second conductive member 34 is inserted in the receptacle hole 42 with the base portion 342 received in the through hole 422 and the flange portion 344 received in the depression 424. The flange portion 344 of the second conductive member 34 is fixed to the first conductive member 32 by the adhesive layer 36. A portion between the first and second conductive members 32, 34 is not applied with the adhesive layer 36 so as to define a through hole 38 in the adhesive layer 36. The through hole 38 can be defined at any position in the adhesive layer 36. In a preferred embodiment, the through hole 38 is defined in a central portion of the adhesive layer 36 to assure that the conductive element 40 can be securely seated and positioned inside the adhesive layer 36.

The conductive element 40 is received in the through hole 38 so that two opposite distal ends of the conductive element 40 connect to the first conductive member 32 and the second conductive member 34 respectively. Thereby, the first and second conductive members 32, 34 are electrically connected. Therefore, when the first conductive member 32 is electrically connected to electronic components (not shown) and any one of the first and second conductive members 32, 34 is grounded (for example, a hand of a user touching the first conductive member 32 or the second conductive member 34), static electricity generated by the electronic components can flow from the electronic device to ground. In the embodiment, the conductive element 40 is a metallic sheet such as a copper sheet or other sheet made of material with high conductivity. The conductive element 40 can also be a small spring or an elastic piece, and can also be conductive powders filled in the through hole 38. The through hole 38 and the conductive element 40 can be any suitable shapes.

In the embodiment, the first and second conductive members 32, 34 are made of metal, and anodic treatment is performed on the first and second conductive members 32, 34 to form an oxide film. A part of the oxide film of the first and second conductive members 32, 34 corresponding to where the conductive element 40 disposed should be removed so that the first and second conductive members 32, 34 and the conductive element 40 can be electrically connected to each other.

Alternatively, the connecting structure 30 may include one or more conductive elements 40 that further defines one or more through holes 38. The adhesive layer 36 and the conductive element 40 may be disposed at other positions between the first and second conductive members 32, 34. For example, the adhesive layer 36 and the conductive element 40 can be disposed between an inner sidewall of the receptacle hole 42 and an outer sidewall of the base portion 342 of the second conductive member 34. The conductive element 40 can be integrally formed with the first conductive member 32 or the second conductive member 34. That is, one of the first and second conductive members 32 or 34 forms a protrusion received in the through hole 38.

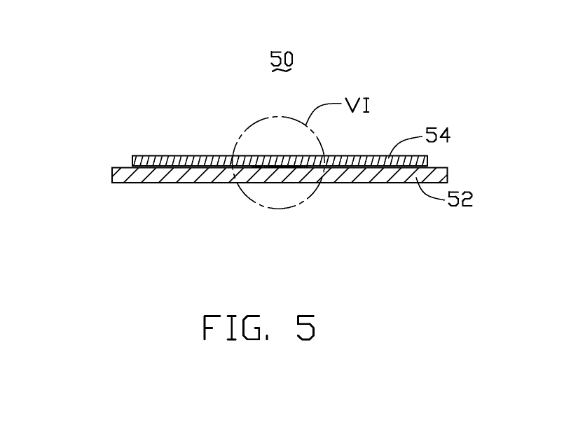

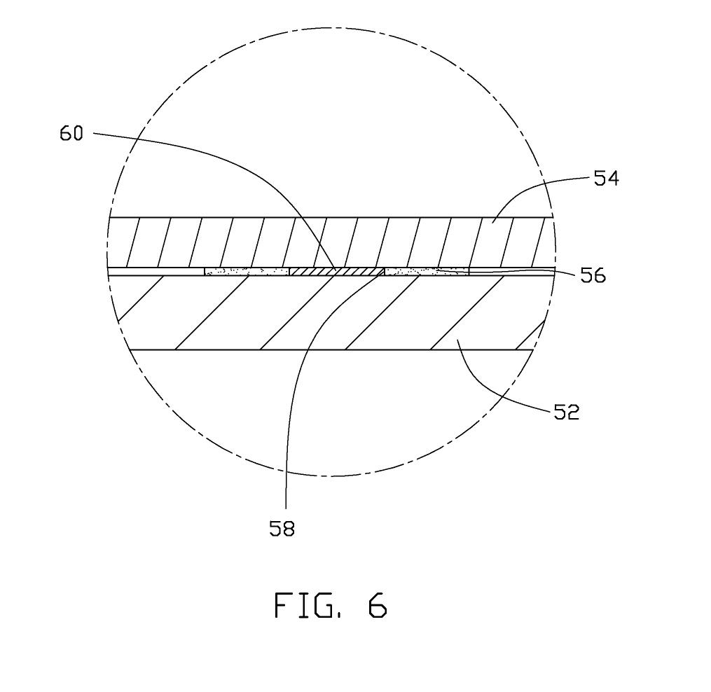

Referring to FIG. 5 and FIG. 6, a connecting structure 50 of a second embodiment is provided. The connecting structure 50 includes an adhesive layer 56 and a conductive element 60 used to connect first and second conductive members 52, 54. A portion of the adhesive layer 56 between the first and second conductive members 52, 54 do not have adhesive layer 56 so as to define a through hole 58 in the adhesive layer 56. The conductive element 60 is received in the through hole 58 so that two opposite distal ends of the conductive element 60 connect to the first conductive member 52 and the second conductive member 54 respectively. Thereby, the first and second conductive members 52, 54 are electrically connected. Therefore, when the first conductive member 52 is electrically connected to electronic components (not shown) and any one of the first and second conductive members 52, 54 is grounded, static electricity generated by the electronic components can be transmitted away from the electronic device. It can be seen that the connecting structure 50 is similar to that of the connecting structure 30 except that the second conductive member 54 is disposed above and parallel to the first conductive member 52.

A connecting method for making the connecting structure 50 includes the following steps: The adhesive layer 56 is adhered onto a surface of the first conductive member 52. A part of the adhesive layer 56 is removed to define the through hole 58. The conductive element 60 is disposed in the through hole 58 and assuring the conductive element 60 electrically connected to the first conductive member 52. The second conductive member 54 is connected to the adhesive layer 56 and the second conductive member 54 is electrically contacting the conductive element 60. In the embodiment, the adhesive layer 56 is adhesive tape with insulating properties. Alternatively, a central portion of the adhesive layer 56 can be not adhered with adhesive tape so as to define the through hole 58. As such, the process of removing a part of the adhesive layer 56 can be omitted.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A connecting structure used to electrically connect two conductive members, the connecting structure comprising:
an adhesive layer connect to the conductive members, the adhesive layer defining at least one through hole; and
at least one conductive element received in the at least one through hole, and the at least one conductive element being electrically connected to the conductive members.

2. The connecting structure as claimed in claim 1, wherein the conductive element is a metal sheet.

3. The connecting structure as claimed in claim 2, wherein the conductive element is a copper sheet.

4. The connecting structure as claimed in claim 1, wherein the conductive element is a spring or an elastic piece.

5. The connecting structure as claimed in claim 1, wherein the conductive element is made from conductive powder.

6. The connecting structure as claimed in claim 1, wherein the conductive element is integrally formed with one of the conductive members.

7. The connecting structure as claimed in claim 1, wherein the conductive members are made of metal, and the conductive members are performed by anodic treatment to form an oxide film, and a part of the oxide film of the conductive members, corresponding to where the conductive element is disposed, is removed.

8. The connecting structure as claimed in claim 1, wherein the adhesive layer is adhesive tape.

9. A connecting method for conductive members comprising:
adhering an adhesive layer onto a first conductive member, the adhesive layer defining a through hole;
disposing a conductive element in the through hole and assuring the conductive element being electrically contacting a first conductive member; and
adhering a second conductive member to the adhesive layer and assuring the second conductive member being electrically contacting the conductive element.

10. The method as claimed in claim 9, wherein a part of the adhesive layer is removed to form the through hole.

11. A connecting method for conductive members comprising:
adhering an adhesive layer onto a first conductive member forming a protrusion thereon, the adhesive layer disposed around the protrusion; and
adhering a second conductive member to the adhesive layer and assuring the second conductive member being electrically contacting the conductive element.
